(19) United States
(12) Patent Application Publication
(10) Pub. No.: US 2024/0124716 A1
(43) Pub. Date: Apr. 18, 2024

(54) CURABLE COATING COMPOSITIONS HAVING SUPERHYDROPHOBIC, ANTI-ICING, AND ANTI-CORROSION PROPERTIES

(71) Applicant: NDSU RESEARCH FOUNDATION, Fargo, ND (US)

(72) Inventors: Zhibin LIN, Fargo, ND (US); Xingyu WANG, Fargo, ND (US); Hong PAN, Fargo, ND (US)

(21) Appl. No.: 18/348,866

(22) Filed: Jul. 7, 2023

Related U.S. Application Data
(60) Provisional application No. 63/359,196, filed on Jul. 7, 2022.

(51) Int. Cl. C09D 5/16; C09D 1/00; C09D 5/00; C09D 7/40; C09D 7/61; C09D 163/00

(52) U.S. Cl. CPC C09D 5/1662; C09D 1/00; C09D 5/002; C09D 7/61; C09D 7/67; C09D 163/00

(57) ABSTRACT

The invention relates to a first curable coating composition comprising a first layer comprising at least one epoxy resin and at least one hybrid nanofiller, and a second layer comprising carbon nanotubes (CNTs). This invention also relates to a second curable coating composition comprising at least one hybrid nanofiller; at least one epoxy resin; and at least one curing agent. This invention also relates to methods of making the curable coating compositions. This invention also relates to methods for coating the surface of a metallic coated substrate.

### CROSS-REFERENCE TO RELATED APPLICATIONS

This application claims priority to U.S. Provisional Application No. 63/359,196, filed Jul. 7, 2022, which is incorporated herein by reference.

### STATEMENT OF U.S. GOVERNMENT SUPPORT

This invention was made with government support under grants 693JK31850009CAAP, 693JK32110003POTA, and DTPH5616HCAP03 awarded by the United States Department of Transportation. The U.S. government has certain rights in the invention.

### BACKGROUND OF THE INVENTION

Carbon fiber reinforced polymer (CFRP) composite has attracted great attention due to its outstanding stiffness, strength-to-weight ratio, and corrosion resistance. Consequently, CFRPs are substituting other materials to fabricate components in many industries, such as aerospace, automotive, and marine. Especially in aerospace engineering, lightweight components could drastically improve the performance of aircraft and many metallic components are gradually replaced by CFRP composites.

Despite the advantage of CFRP mentioned, the major challenges of replacing metallic components are the significantly reduced electrical conductivity. As the average number of aircraft subjected to lightning strikes is around two times per year, the high electrical resistivity of CFRP components may be significantly damaged by lightning strikes. To increase the electrical conductivity of the CFRP components, one of the most preferred methods is to coat a layer of metallic material to the surface of the polymer. Additionally, metalizing the CFRP surface also improves the corrosion resistance and thermal conductivity of the components.

Extensive efforts have been devoted to deposit a metallic coating on polymer surfaces; however, the main drawback of metalized polymer materials is the metallic layer's porosity, which is caused by polymers' intrinsically poor adhesion to metals. Researchers have pointed out that the metal particles are non-continuously adhered to the nonmetallic surface. Studies found that the intrinsic pores and cracks will not be eliminated even if the application parameters are optimized. The high porosity in the metallic coating also leads to the formation of open pores and large cracks in the metallic coating. These defects can degrade the properties of the metallic coating, which has a negative effect on the electrical conductivity and protective properties, thereby drastically inhibiting the functionality of components and limiting the application of metalized CFRP composites.

In addition, metallic coatings exhibit low water repellency and anti-icing properties; however, both properties are relative to the ice accumulation on the instrument in aerospace, marine, and automobiles. The ice deposition may lead to several negative consequences, such as increased energy consumption, reduced performance, sustained damages, or instrument failure. Therefore, an anti-icing surface is highly beneficial for the system that may be subjected to ice accumulation. However, despite the significant efforts made to design water-repellent and anti-icing surfaces, researchers and industries still a face major challenge, which is their low mechanical robustness. Researchers pointed out that many developed superhydrophobic and anti-icing surfaces are delicate as they can be severely deteriorated by light friction.

To address the gaps just mentioned, the present invention is directed to a facile approach to developing a robust self-cleaning nanocomposite adhering to metalized CFRP components' surfaces. This invention mitigates the defects in the metallic coating, enhancing the electrical conductivity, introducing superhydrophobic and anti-icing surfaces with high mechanical robustness.

The invention thus relates to a new duplex nanocomposite coating to adhere a metallic layer that is deposited to CFRP plates. See, e.g., FIG. 1.

The coating system of the invention provides improvements and also introduces new properties to the metallic coated CFRP composites. First, the nanofiller polymer coating eliminates the open pores and defects in the metallic coating layer, improving the system's overall performance and durability. Secondly, the presence of nanocomposite increases the adhesion of a metallic coating to the CFRP substrate. Meanwhile, due to the excellent mechanical and barrier properties introduced by hybrid nanofiller reinforcement, the presence of a nanocomposite layer also provides great protection properties to the system. Thus, because of the homogeneously distributed carbon nanotubes (CNTs), the coating surface exhibits extraordinary electrical conductivity as the CNTs generally have electrical conductivity around 10⁶ to 10⁷ S/m while aluminum is around 3.5*10⁶ S/m. In addition, the coating system of the invention has excellent water-repellency and anti-icing property due to the CNTs, with both greatly delayed freezing time and reduced ice particle formation. Furthermore, the coating surface of the invention displays great physical stability, which shows excellent resistance to abrasion damages. These phenomena are attributed to 1) the strong adhesion between CNT and polymer, 2) the outstanding strength and flexibility of CNTs.

The invention disclosed herein also relates to a graphene nanoplatelets (GNP)-carbon 60 (C60) hybrid nanofiller to reinforce polymeric coatings to enhance their protective properties to metallic substrates. The nanofiller reinforcement increases the corrosion resistance, abrasion resistance, and mechanical properties of the polymeric coating.

The GNP-C60 polymeric coatings have dramatically improved anti-corrosion performance, and the coating displayed long-term resistance after exposure to accelerated weathering environments. The GNP-C60 polymeric coatings also had improved critical mechanical properties for engineering applications, such as strength, strain, and Young's modulus. The coatings also displayed a reduced mass loss after abrasion, indicating a significantly enhanced wear resistance.

### SUMMARY OF THE INVENTION

The invention relates to a first curable coating composition comprising, consisting essentially of, or consisting of:
a) a first layer comprising at least one epoxy resin and at least one hybrid nanofiller; and
b) a second layer comprising carbon nanotubes (CNTs).

This invention also relates to a metallic coated substrate composite comprising, consisting essentially of, or consisting of:
a) a substrate;
b) a metallic layer deposited on at least a part of at least one surface of the substrate; and
c) the first curable coating composition of the invention deposited on at least a part of the surface of the metallic layer.

This invention also relates to a method for coating the surface of a metallic coated substrate comprising, consisting essentially of, or consisting of the steps of:
providing a substrate, wherein at least a part of at least one surface of the substrate is coated with a metallic layer;
applying the first layer of the first curable coating composition of the invention to at least a part of the surface of the metallic layer to form a first coated surface;
applying the second layer of the first curable coating composition of the invention to at least a part of the surface of the first coated surface to form a second coated surface; and
curing the first coated surface.

This invention also relates to a second curable coating composition comprising, consisting essentially of, or consisting of:
a) at least one hybrid nanofiller;
b) at least one epoxy resin; and
c) at least one curing agent.

This invention also relates to a method of making the second curable coating composition, comprising, consisting essentially of, or consisting of the steps of:
dispersing the hybrid nanofiller in the epoxy resin to form a slurry; and
adding the curing agent to the slurry.

This invention also relates to a metallic coated substrate composite comprising consisting essentially of, or consisting of:
a) a substrate; and
b) the second curable coating composition deposited on at least a part of the surface of the substrate.

This invention also relates to a method for coating the surface of a metallic coated substrate comprising, consisting essentially of, or consisting of the steps of:
providing a substrate;
applying the second curable coating composition to at least a part of the surface of the substrate to form a first coated surface; and
curing the first coated surface.

### BRIEF DESCRIPTION OF THE FIGURES

FIG. 1 shows a schematic illustration of metalized CFRP composite coated with hybrid-filler reinforced nanocomposite and CNT modification.

FIGS. 2(a)-2(f) show a fabrication of metalized CFRP composite coated with hybrid-filler reinforced nanocomposite and CNT modification.

FIG. 3(a) shows a photo of the surface of the metalized CFRP plate, FIG. 3(b) shows a photo of pixel-based color analysis on the surface, and FIG. 3(c) shows a micro-computed tomography (CT) image of a cross-section of the metalized CFRP plate.

FIGS. 4(a) and 4(b) show the surface of metalized CFRP plate provided by Micro-CT (FIG. 4(a)), and scanning electron microscopy (SEM) (FIG. 4(b)).

FIGS. 5(a) and 5(b) show the surface of hybrid-filler reinforced nanocomposite coated metalized CFRP plate provided by Micro-CT (FIG. 5(a)), and SEM (FIG. 5(b)).

FIG. 6(a)-6(c) show the tensile strength (FIG. 6(a)), failure strain (FIG. 6(b)), and Young's modulus (FIG. 6(c)) of the hybrid-filler reinforced nanocomposite.

FIGS. 7(a) and 7(b) show the fracture surface of neat epoxy (FIG. 7(a)) and 1% GNP-fullerene (GF)-epoxy (25:75) hybrid-filler reinforced nanocomposite (FIG. 7(b)).

FIG. 8 shows the mass loss of the hybrid-filler reinforced nanocomposite.

FIGS. 9(a) and 9(b) show the SEM images of the abraded surface of the neat epoxy (FIG. 9(a)) and 1% GF-epoxy (25:75) hybrid-filler reinforced nanocomposite (FIG. 9(b)).

FIGS. 10(a) and 10(b) show the photo of the example after adhesion test, metalized CFRP composite (FIG. 10(a)) and hybrid-filler reinforced nanocomposite coated metalized CFRP composite (FIG. 10(b)).

FIG. 11(a)-11(d) show the photo of water spreading on the surface of metalized CFRP composite (FIG. 11(a)), water droplets on the coating surface with CNT layer (FIG. 11(b)), contact angle of the coating surface with CNT layer (FIG. 11(c)), SEM image of the surface after CNT modification (FIG. 11(d)).

FIGS. 12(a) and 12(b) show the results of icing-delay performance when the water droplet is on the metalized CFRP composite (FIG. 12(a)) and when a water droplet is on the coating surface with the CNT layer (FIG. 12(b)).

FIG. 13(a)-13(c) show the results of the water-dripping test. FIG. 13(a) shows the schematic illustration of the water-dripping test. FIG. 13(b) shows when the water droplet is on the metalized CFRP composite. FIG. 13(c) shows when the water droplet is on the coating surface with CNT layer.

FIG. 14(a)-14(c) show the evaluation on mechanical robustness of the coating surface with CNT layer. FIG. 14(a) shows the Taber Abraser tester. FIG. 14(b) shows a photo of the surface after 2000 cycles. FIG. 14(c) shows the water contact angle after abrasion test.

FIG. 15 shows the viscosity of epoxy mixed with GNP-CNT and GNP-C60 nanofillers.

FIG. 16 shows the particle size distribution of GNP-C60 nanoparticles.

FIG. 17(a)-17(c) shows the micro-CT scan images of the neat epoxy.

FIG. 18(a)-18(c) shows the micro-CT images of GNP-C60 nanocomposites GNP/fullerene ratio 25:75 (FIG. 18(a)), GNP/fullerene ratio 50:50 (FIG. 18(b)), and GNP/fullerene ratio 75:25 (FIG. 18(c)).

FIG. 19(a)-19(c) show the defect analysis of GNP-C60 nanocomposites.

FIG. 20(a)-20(b) show the bode plots of GNP-C60 epoxy coatings.

FIG. 21(a)-21(f) show the impedance curve and phase angle curve of the GNP-C60 epoxy after 100 hours (FIG. 21(a) and FIG. 21(b)), 200 hours (FIG. 21(c) and FIG. 21(d)), and 500 (FIG. 21(e) and FIG. 21(f)).

FIG. 22(a)-22(c) show the tensile properties of GNP/fullerene-C60 reinforced epoxy composite. FIG. 22(a) shows the tensile strength of the composite. FIG. 22(b) shows the ultimate strain the composite can experience until failure. FIG. 22(c) shows the Young's modulus for the composite.

FIG. 23 shows the mass loss of the GNP/fullerene-C60 reinforced epoxy coatings.

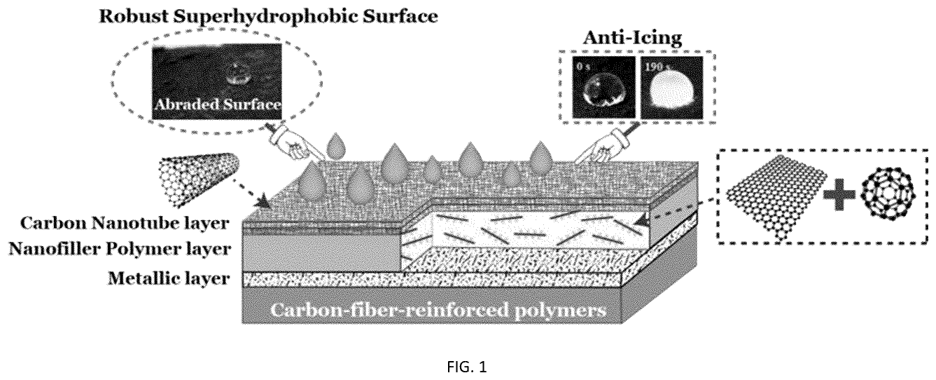

### DETAILED DESCRIPTION OF THE INVENTION

The invention relates to a first curable coating composition comprising, consisting essentially of, or consisting of:
a) a first layer comprising at least one epoxy resin and at least one hybrid nanofiller; and
b) a second layer comprising CNTs.

The coating of the first curable coating composition of the invention may be superhydrophobic.

The epoxy resin of the first curable coating composition of the invention may be selected from the group consisting of bisphenol-based resin, novolac resin, aliphatic resin, halogenated resin, diluent resin, glycidol amine resin, and mixtures thereof. For example, the epoxy resin may be selected from a bisphenol A/epichlorohydrin epoxy resin (e.g., EPON Resin 828). The epoxy resin may be present in the first layer of the coating composition in an amount ranging from about 35-65 wt. % (e.g., 40-60 wt. %, 45-55 wt. %, 47-50 wt. %), based on the total solid content of the first layer.

The hybrid nanofiller of the first curable coating composition of the invention may be present in the first layer in an amount ranging from about 0.1-10 wt. % (e.g., 0.15-9 wt. %, 0.2-8 wt. %, 0.5-7 wt. %, 1-6 wt. %, 2-5 wt. %, 3-4 wt. %), based on the total solid content of the first layer. For example, the hybrid nanofiller may be present in an amount of 1 wt. %. The hybrid nanofiller may comprise GNP and fullerene-C60 nanopowder. The ratio of GNP:fullerene-C60 nanopowder may be present in the first layer of the coating composition in an amount ranges from about 25:75 to 75:25 (e.g., 30:70 to 70:30, 35:65 to 65:35, 40:60 to 60:40, 45:55 to 55:45, 50:50). The GNP may have an average thickness of about 8-12 nm and an average specific surface area of about 500-700 m²/g. The fullerene-C60 nanopowder may have an average particle size of about 20 nm.

The first layer of the first curable coating composition of the invention may further comprise at least one curing agent. The curing agent may be selected from the group consisting of at least one polyamine, at least one polyamide, and mixtures thereof. The curing agent may be a polyamide curing agent (e.g., Epikure 3175). The mol ratio of the epoxy resin to the at least one curing agent may be in the ranges between 1:0.08 and 1:1.25 (e.g., 1:1).

The CNTs of the first curable coating composition of the invention may be uniformly distributed in the second layer of the first curable coating composition of the invention. The CNTs may have an average outside diameter of about 8-15 nm and may have an average length of about 10-50 um.

The invention also relates to a metallic coated substrate composite comprising, consisting essentially of, or consisting of:
a) a substrate;
b) a metallic layer deposited on at least a part of at least one surface of the substrate; and
c) the first curable coating composition deposited on at least a part of the surface of the metallic layer.

The metallic coated substrate of the invention may be a CFRP. The metallic layer may comprise an aluminum alloy. The first curable coating composition on the metallic coated substrate may be cured to form a cured coating composition.

The invention also relates to a method for coating the surface of a metallic coated substrate comprising, consisting essentially of, or consisting of the steps of:
providing a substrate, wherein at least a part of at least one surface of the substrate is coated with a metallic layer;
applying the first layer of the first curable coating composition to at least a part of the surface of the metallic layer to form a first coated surface;
applying the second layer of the first curable coating composition to at least a part of the surface of the first coated surface to form a second coated surface; and
curing the first coated surface.

The substrate of the invention may be a CFRP.

The invention also relates to a second curable coating composition comprising, consisting essentially of, or consisting of:
a) at least one hybrid nanofiller;
b) at least one epoxy resin; and
c) at least one curing agent.

The hybrid nanofiller of the second curable coating composition of the invention may be present in an amount ranging from about 0.1-10 wt. % (e.g., 0.15-9 wt. %, 0.2-8 wt. %, 0.5-7 wt. %, 1-6 wt. %, 2-5 wt. %, 3-4 wt. %), based on the total solid content of the second curable coating composition. For example, the hybrid nanofiller may be present in an amount of 1 wt. %. The hybrid nanofiller may comprise GNP and fullerene-C60 nanopowder. The ratio GNP:fullerene-C60 nanopowder may be in the ranges from about 25:75 to 75:25 (e.g., 30:70 to 70:30, 35:65 to 65:35, 40:60 to 60:40, 45:55 to 55:45, 50:50). The GNP may have an average thickness of about 8-12 nm. The curable coating fullerene-C60 nanopowder may have an average particle size of about 20 nm.

The epoxy resin of the second curable coating composition of the invention may be selected from the group consisting of bisphenol-based resin, novolac resin, aliphatic resin, halogenated resin, diluent resin, glycidol amine resin, and mixtures thereof. The epoxy resin may be selected from bisphenol A/epichlorohydrin epoxy resin (e.g., EPON® Resin 828).

The curing agent of the second curable coating composition of the invention may be selected from the group consisting of at least one polyamine, at least one polyamide, and mixtures thereof. The curing agent may be a polyamide curing agent (e.g., EPIKURE® 3175). The mol ratio of the epoxy resin to the at least one curing agent may be in the ranges between 1:0.08 and 1:1.25 (e.g., 1:1).

The invention also relates to a method of making the second curable coating composition, comprising, consisting essentially of, or consisting of steps of:
dispersing the hybrid nanofiller in the epoxy resin to form a slurry; and
adding the curing agent to the slurry.

The second curable coating composition of the invention may be cured to form a cured coating composition. Thus, the invention also relates to a cured coating composition, comprising, consisting essentially of, or consisting of the second curable coating composition, wherein the curable coating composition is cured.

The cured coating composition of the invention may be corrosion resistant and/or abrasion resistant.

The invention also relates to a metallic coated substrate (e.g., steel, cast iron, aluminum) composite comprising, consisting essentially of, or consisting of:
a) a substrate; and
b) the second curable coating composition deposited on at least a part of the surface of the substrate.

The invention also relates to a method for coating the surface of a metallic coated substrate (e.g., steel, cast iron, aluminum) comprising, consisting essentially, or consisting of the steps of:
providing a substrate;
applying the second curable coating composition to at least a part of the surface of the substrate to form a first coated surface; and
curing the first coated surface.

### Exemplary Embodiments

E1) A curable coating composition comprising, consisting essentially of, or consisting of:
a) a first layer comprising at least one epoxy resin and at least one hybrid nanofiller; and
b) a second layer comprising carbon nanotubes (CNTs).
E2) The curable coating composition of E1, wherein the coating is superhydrophobic.
E3) The curable coating composition of E1 or E2, wherein the epoxy resin is selected from the group consisting of bisphenol-based resin, novolac resin, aliphatic resin, halogenated resin, diluent resin, glycidol amine resin, and mixtures thereof.
E4) The curable coating composition of any one of E1-E3, wherein the epoxy resin is selected from a bisphenol A/epichlorohydrin epoxy resin (e.g., EPON Resin 828).
E5) The curable coating composition of any one of E1-E4, wherein the epoxy resin is present in the first layer in an amount ranging from about 35-65 wt. % (e.g., 40-60 wt. %, 45-55 wt. %, 47-50 wt. %), based on the total solid content of the first layer.
E6) The curable coating composition of any one of E1-E5, wherein the hybrid nanofiller is present in the first layer in an amount ranging from about 0.1-10 wt. % (e.g., 0.15-9 wt. %, 0.2-8 wt. %, 0.5-7 wt. %, 1-6 wt. %, 2-5 wt. %, 3-4 wt. %), based on the total solid content of the first layer.
E7) The curable coating composition of any one of E1-E6, wherein the hybrid nanofiller comprises GNP and fullerene-C60 nanopowder.
E8) The curable coating composition of E7, wherein the ratio of GNP:fullerene-C60 nanopowder in the first layer ranges from about 25:75 to 75:25 (e.g., 30:70 to 70:30, 35:65 to 65:35, 40:60 to 60:40, 45:55 to 55:45, 50:50).
E9) The curable coating composition of E7 or E8, wherein the GNP has an average thickness of about 8-12 nm and an average specific surface area of about 500-700 m²/g.
E10) The curable coating composition of any one of E7-E9, wherein the fullerene-C60 nanopowder has an average particle size of about 20 nm.
E11) The curable coating composition of any one of E1-E10, wherein the first layer further comprises at least one curing agent.
E12) The curable coating composition of E11, wherein the curing agent is selected from the group consisting of at least one polyamine, at least one polyamide, and mixtures thereof.
E13) The curable coating composition of E11 or E12, wherein the curing agent is a polyamide curing agent (e.g., Epikure 3175).
E14) The curable coating composition of any one of E11-E13, wherein the mol ratio of the epoxy resin to the at least one curing agent ranges between 1:0.08 and 1:1.25 (e.g., 1:1).
E15) The curable coating composition of any one of E1-E14, wherein the CNTs are uniformly distributed in the second layer.
E16) The curable coating composition of any one of E1-E15, wherein the CNTs have an average outside diameter of about 8-15 nm and an average length of about 10-50 um.
E17) A metallic coated substrate composite comprising:
a) a substrate;
b) a metallic layer deposited on at least a part of at least one surface of the substrate; and
c) the curable coating composition of any one of E1-E16 deposited on at least a part of the surface of the metallic layer.
E18) The metallic coated substrate of E17, wherein the substrate is a CFRP.
E19) The metallic coated substrate of E17 or E18, wherein the metallic layer comprises an aluminum alloy.
E20) The metallic coated substrate of any one of E17-E19, wherein the curable coating composition is cured to form a cured coating composition.
E21) A method for coating the surface of a metallic coated substrate comprising the steps of:
providing a substrate, wherein at least a part of at least one surface of the substrate is coated with a metallic layer;
applying the first layer of the curable coating composition of any one of E1-E16 to at least a part of the surface of the metallic layer to form a first coated surface;
applying the second layer of the curable coating composition of any one of E1-E16 to at least a part of the surface of the first coated surface to form a second coated surface; and curing the first coated surface.
E22) The method of E21, wherein the substrate is a CFRP.
E23) A curable coating composition comprising:
a) at least one hybrid nanofiller;
b) at least one epoxy resin; and
c) at least one curing agent.
E24) The curable coating composition of E23, wherein the hybrid nanofiller is present in an amount ranging from about 0.1-10 wt. % (e.g., 0.15-9 wt. %, 0.2-8 wt. %, 0.5-7 wt. %, 1-6 wt. %, 2-5 wt. %, 3-4 wt. %), based on the total solid content of the curable coating composition.
E25) The curable coating composition of E23 or E24, wherein the hybrid nanofiller comprises GNP and fullerene-C60 nanopowder.
E26) The curable coating composition of E25, wherein the ratio GNP:fullerene-C60 nanopowder ranges from about 25:75 to 75:25 (e.g., 30:70 to 70:30, 35:65 to 65:35, 40:60 to 60:40, 45:55 to 55:45, 50:50).
E27) The curable coating composition of E25 or E26, wherein the GNP has an average thickness of about 8-12 nm.
E28) The curable coating composition of any one of E25-E27, wherein the fullerene-C60 nanopowder has an average particle size of about 20 nm.
E29) The curable coating composition of any one of E23-E28, wherein the epoxy resin is selected from the group consisting of bisphenol-based resin, novolac resin, aliphatic resin, halogenated resin, diluent resin, glycidol amine resin, and mixtures thereof.
E30) The curable coating composition of any one of E23-E29, wherein the epoxy resin is selected from bisphenol A/epichlorohydrin epoxy resin (e.g., EPON® Resin 828).
E31) The curable coating composition of any one of E23-E30, wherein the curing agent is selected from the group consisting of at least one polyamine, at least one polyamide, and mixtures thereof.
E32) The curable coating composition of any one of E23-E31, wherein the curing agent is a polyamide curing agent (e.g., EPIKURE® 3175).
E33) The curable coating composition of any one of E23-E32, wherein the mol ratio of the epoxy resin to the at least one curing agent ranges between 1:0.08 and 1:1.25 (e.g., 1:1).
E34) A method of making the curable coating composition of any one of E23-E33, comprising the steps of:
dispersing the hybrid nanofiller in the epoxy resin to form a slurry; and
adding the curing agent to the slurry.
E35) A cured coating composition, comprising the curable coating composition of any one of E23-E33.
E36) The cured coating composition of E35, wherein the cured coating composition is corrosion resistant.
E37) The cured coating composition of E35 or E36, wherein the cured coating composition is abrasion resistant.
E38) A metallic coated substrate composite comprising:
a) a substrate; and
b) the curable coating composition of any one of E23-E33 deposited on at least a part of the surface of the substrate.
E39) The metallic coated substrate of E38, wherein the substrate is steel.
E40) The metallic coated substrate of E38 or E39, wherein the curable coating composition is cured to form a cured coating composition.
E41) A method for coating the surface of a metallic coated substrate comprising the steps of:
providing a substrate;
applying the curable coating composition of any one of E23-E33 to at least a part of the surface of the substrate to form a first coated surface; and
curing the first coated surface.
E42) The method of E41, wherein the substrate is steel.

### EXAMPLES

### Example 1: Robust Superhydrophobic and Anti-Icing Duplex Coating for Metalized Carbon Fiber Reinforced Polymer Composites

1.1 Materials

The substrates used in the examples are CFRP composite plates that are coated with 6000 series Aluminum alloy (99.5% Aluminum), and the thickness was controlled as 100 μm. The CFRP plates were cleaned in acetone and ethanol before the coating process, and the same cleaning procedure was performed after the deposition process with aluminum.

All the materials were purchased commercially and used without modification or treatment. The fullerene-C60 nanopowders were purchased from Sigma-Aldrich Inc., with an average particle size around 20 nm. GNPs and CNTs were obtained from Cheap Tubes Inc.; thus, the average thickness and specific surface area of GNP is 8 to 12 nm and 500-700 m²/g, and the average outside diameter and length of CNTs is around 8-15 nm and 10-50 μm. The epoxy resin used in the examples is EPON™ Resin 828, a bisphenol-A epoxy resin, which is crosslinked by Epikure 3175, a polyamide curing agent.

1.2 Fabrication Process

1.2.1 Preparation of the Nanocomposite

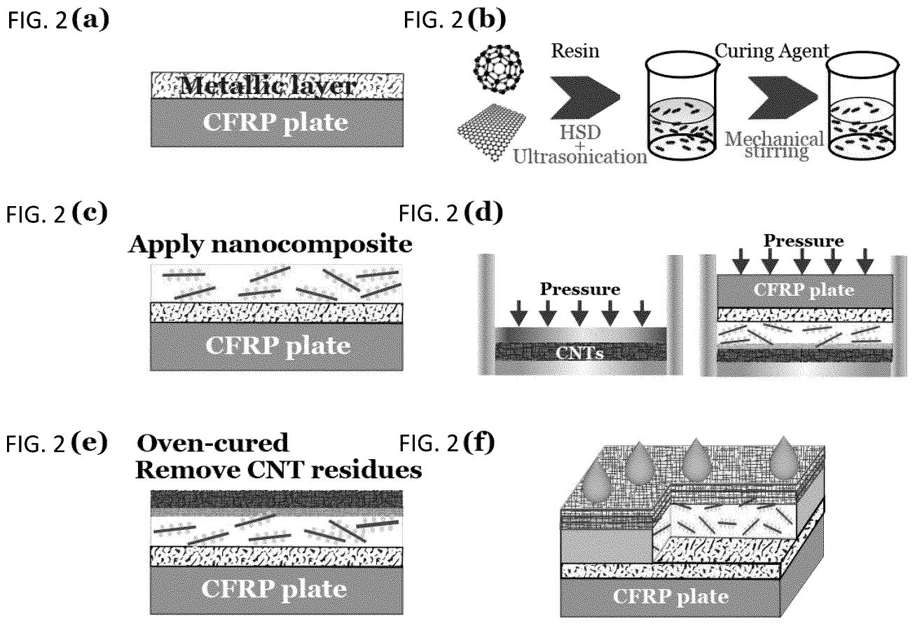

FIG. 2(b) presents the preparation process of the nanocomposite reinforced by hybrid nanofillers (GNP+C60). Two techniques were employed to disperse nanofillers into the epoxy resin, including high-speed disperser and ultrasonication. First, the nanofillers were mixed into EPON 828 resin by using a high-speed disperser, and the introduced shear stress broke down the large aggregates. During the 30 mins of dispersion, the disperser was controlled with a rotational speed of 4000 rpm, and an ice-water bath was used to prevent overheating during the process.

The solution was followed by ultrasonication to achieve better-dispersed nanofillers; thus, a ¾″ probe was used, and the amplitude was 100%. In addition, the total duration of ultrasonication was 60 mins and 30 seconds on/off cycle was employed. Furthermore, the EPIKURE™ curing agent 3175 was added to the nanoparticle dispersion, and the mole ratio between resin and curing agent was 1:1, and a mechanical mixer was used at a speed of 600 revolutions per minute for ten minutes. The weight content of hybrid nanofillers was fixed at 1%, and three different mix ratios of GNP and C60 were studied in this work: 25:75, 50:50, and 75:25. For simplicity, the nanocomposites were labeled by the nanofiller's type and ratio; for example, the GF-epoxy (25:75) is the group that contains GNP and fullerene with a ratio of 25:75.

1.2.2 Fabrication of the Duplex Coating of the Invention

The manufacturing process of the duplex coating system of the invention is illustrated in FIG. 2(a) and FIG. 2(c) to FIG. 2(f). First, the nanofiller reinforced composite was fabricated, as described in the previous section. Then nanocomposite was dip-coated to the metallic-coated CFRP plate, which allows the coating to cover the top surface of metallic coating and fill the open pores. Then the example was air-dried for 2 hours to increase the viscosity by the curing process.

Meanwhile, a uniform layer of CNT was prepared at the bottom of a container by compression, with a thickness around 0.5 cm. After that, the example was pressed to the CNT layer, with a stress of 2.0 kPa and a duration of 30 seconds. With the previous process, the coating surface has adhered to a concentrated layer of CNT, which introduced the system's superhydrophobic surface. The example was then placed in an oven for the final curing process, with a temperature of 60° C. and a duration of 15 mins. After removing the CNT residues, the example was allowed to completely dry by leaving at room temperature for two days.

1.3 Characterization

1.3.1 Defects in Hard Coating Layer

The defects and pores generated in the metallic coating during the deposition and formation process have negative impacts on the mechanical, electrical, and protection properties of the coating. Especially for the open pores that expose the substrate to the environment could significantly degrade the performance and reduce the service life of the whole structure. SEM and Micro-CT scan were utilized to characterize the defects in the plasma-sprayed aluminum coating on a CFRP plate. In addition, pixel-based color analysis was used to calculate the exposed area of the CFRP substrate.

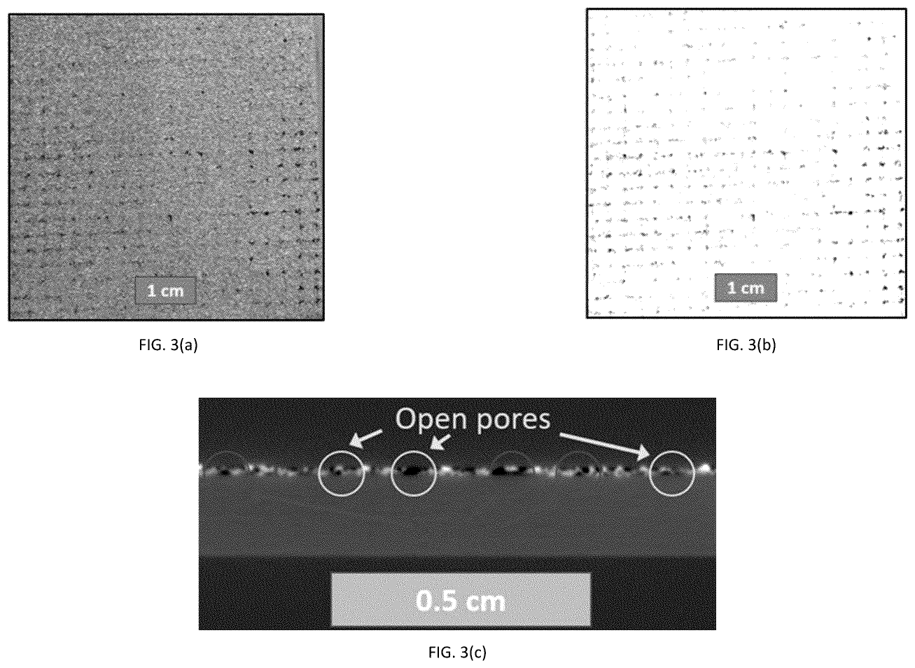

As shown in FIG. 3(a), the Aluminum coated CFRP sample had dark spots; clearly, these spots are the uncovered areas of CFRP substrate. In FIG. 3(b), the dark spots were extracted, and the percentage of the defected area was calculated as follows:

defect rate (%)=(A_{defected area}/Aₜₒₜₐₗ)*100

The defect rate for the coated sample was about 2%, indicating 2% of CFRP plate was exposed to the surrounding environment. Furthermore, the size of defected spots was mostly distributed in the range of 0.02 to 0.10 cm, and the largest ones reached up to 0.13 cm.

The cross-sectional image of the sample was obtained by a Micro-CT scan, which is presented in FIG. 3. The results further confirmed the existence of open pores; in addition, voids in the metallic layer were observed, and these voids can also degrade the performance of the metallic coating.

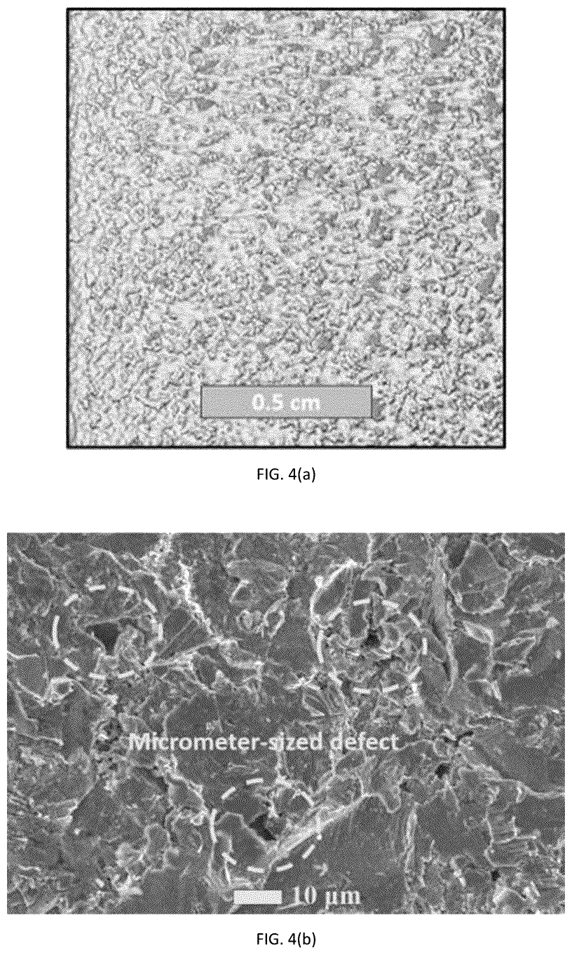

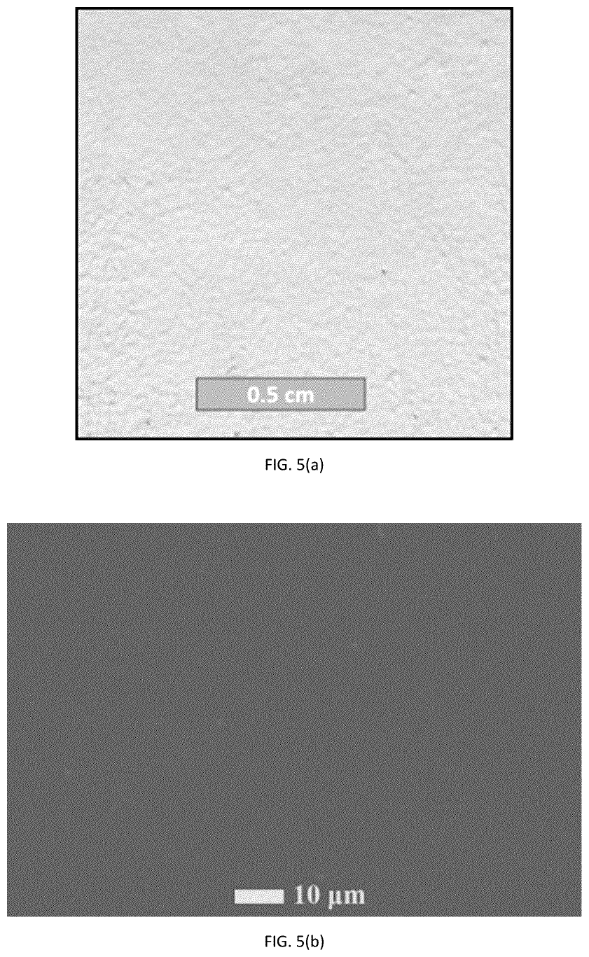

Besides the macro-sized defect presented above, the SEM image was used to characterize the micro-scale defects, as shown in FIG. 4(a). The morphography indicated the metallic coating has a rough surface and is covered by micro-cracks and pores. The micro-cracks around 20 μm and pores around 10 μm are found in FIG. 4(b).

1.3.2 Mitigation of the Defects

The SEM images and Micro-CT scan were used to characterize the top surface of the sample after applying nanocomposite coating, shown in FIG. 5(a) and FIG. 5(b). There was significant interaction between the nanofiller reinforced coating and metallic coating, as the nanocomposite coating fully covered the top surface without any macro/micro level cracks or pores. The result indicated that the nanocomposite coating mitigated the defects on the surface of metallic coating, improving the overall performance, and protecting the CFRP substrate.

1.4 Nanofiller Reinforced Coating Performance

Section 1.4.1 and 1.4.2 below present the mechanical properties and abrasion resistance of the nanofiller reinforced coating. As described above, the added nanofillers were controlled with a total weight ratio of 1%. In addition, the GNP and C60 nanofillers were mixed with a ratio of 25:75, 50:50, and 75:25 to examine the “hybrid effect” of the binary nanofiller reinforcements.

1.4.1 Mechanical Properties of the Nanocomposite

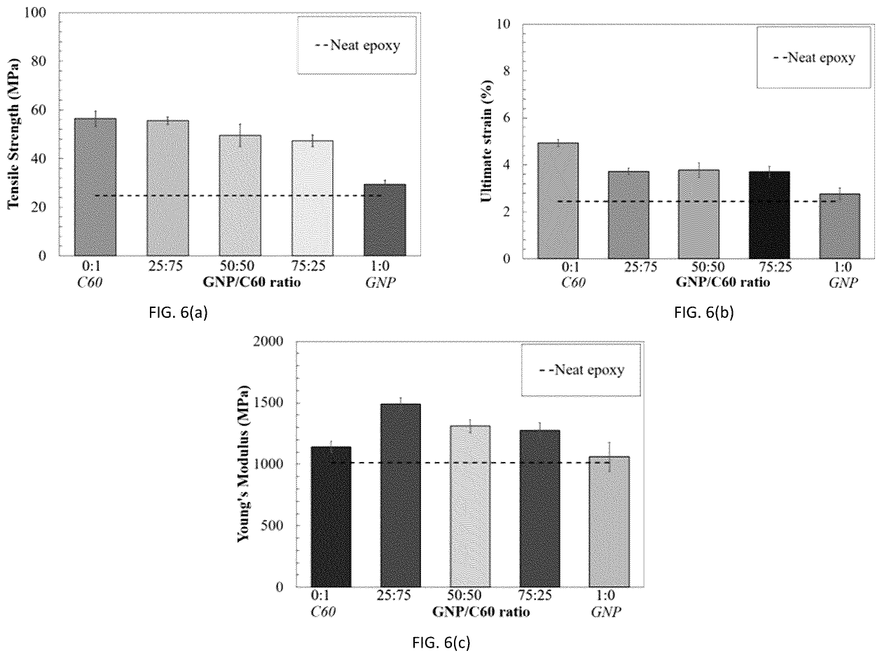

The tensile properties of the nanocomposites were evaluated by measuring maximum tensile stress, strain at failure, and Young's modulus during the test. FIG. 6(a) shows the maximum tensile stress of the tested nanocomposites with varied nanofillers. The results revealed that, compared with the neat epoxy, an improvement of tensile stress was obtained in all tested nanofiller reinforced composites. Similar to abrasion resistance, the reinforcement of fullerene-C60 nanoparticles was stronger than the GNP nanoplatelets. However, 1% fullerene (F)-epoxy and 1% GF-epoxy (25:75) composites had the highest tensile strength, in which the maximum stress was around 55 MPa. The addition of a higher amount of GNP resulted in a slight reduction in the tensile strength as a value around 49 and 47 MPa was obtained in 1% GF-epoxy (50:50) and 1% GF-epoxy (75:25), respectively.

Unlike the tensile stress curve, FIG. 6(b) shows that higher failure strain was obtained in the composites that were reinforced by only fullerene-C60. A reduction on the strain values was obtained in groups with GNP content; these results indicated that the presence of GNP led to a decrease in the flexibility of the composites. On the other hand, the Young's modulus curves displayed in FIG. 6(c) revealed that the 1% GF-epoxy (25:75) group had the largest increase of 47% while the other hybrid filler systems also exhibited significant enhancement in Young's modulus. Therefore, the results suggested that the addition of fullerene-C60 would dramatically increase the strength and strain of the epoxy resin. The addition of GNP in the composites would slightly reduce the strain of C60-epoxy composite but significantly improve the composites' stiffness (Young's modulus). The 1% GF-epoxy (25:75) group exhibited the strongest overall tensile properties in the hybrid nanofiller composites.

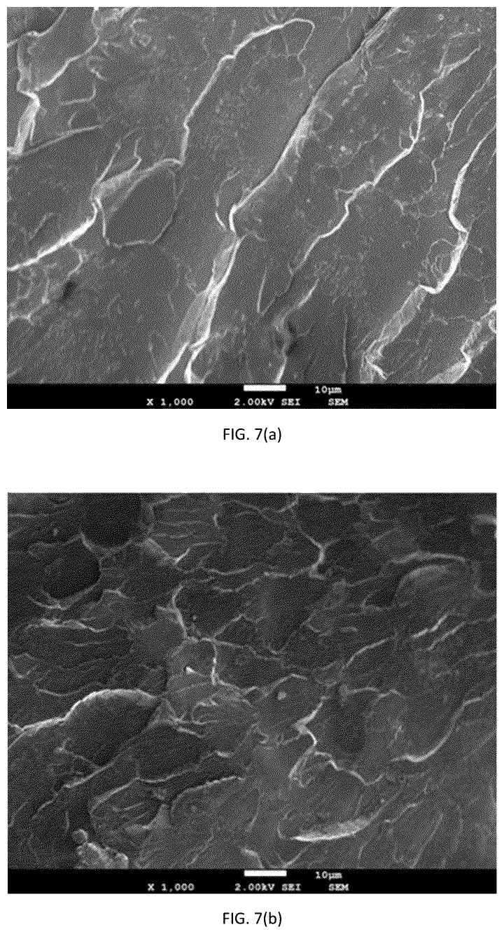

FIG. 7(a) and FIG. 7(b) show the fracture surfaces for examples that fractured under tensile stress. Neat epoxy had a relatively smooth surface compared with nano-reinforced composites. This typical brittle fracture from pure epoxy represents the low impact resistance and fracture toughness of the neat epoxy (FIG. 7(a)). In contrast, the fracture surface was significantly rougher for all the nanocomposites than the pure epoxy, especially for the composites containing GNP/C60 fillers with a mix ratio of 25:75 (FIG. 7(b)), where higher surface roughness and more compacted cleavages were observed, indicating the signs of higher energy absorption and better fracture resistance. This observation was consistent with the experimental results obtained from the tensile test.

1.4.2 Abrasion Resistance of the Nanocomposite

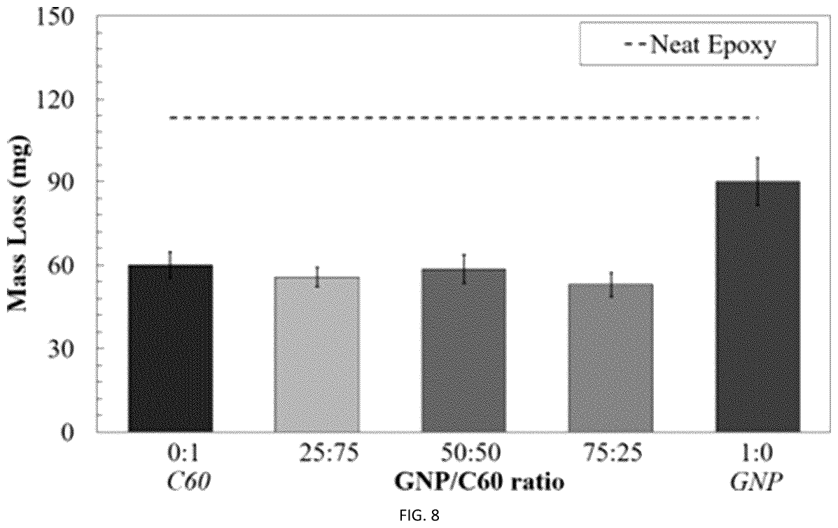

FIG. 8 shows the mass loss value from the abrasion test; thus, the neat epoxy was used as a reference to compare with all the nanofiller reinforced coatings, and the mass loss of the neat epoxy film was 114 mg after 1000 abrasion cycles. C60 and GNP reinforced epoxy showed improvement in abrasion resistance, in which the mass loss was around 60 and 90 mg, respectively. Apparently, the addition of both GNP and fullerene-C60 improved the abrasion resistance of the epoxy resin, but the improvement of fullerene-C60 was significantly stronger than graphene nanoplatelets. For the composites containing hybrid nanofiller, the presence of fullerene-C60 dramatically increased the abrasion resistance, as the mass loss values of all the GF-epoxy groups were lower than the epoxy that contained only GNP nanofillers. In particular, the mass loss of GF-epoxy groups was slightly lower than the C60/epoxy group, indicating the hybrid nanofiller systems have a more robust nanoparticles network against the abrasive force. 1% GF-epoxy (25:75) and 1% GF-epoxy (75:25) groups had the highest reinforcement on abrasion resistance, in which the mass loss was around 54 mg after 1000 abrasion cycles.

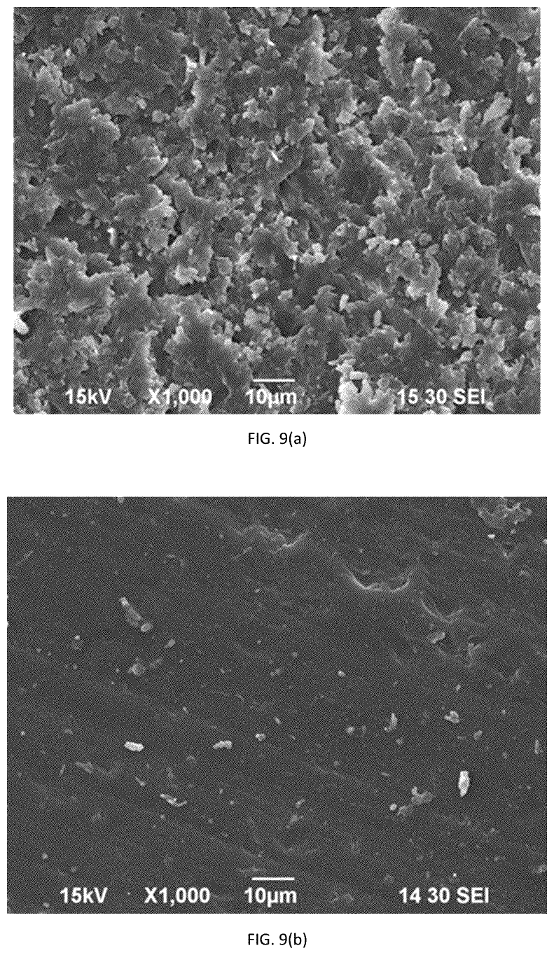

The worn surfaces of neat epoxy and 1% GF-epoxy (25:75) composite were selected as representatives to identify the surface properties of the samples after the abrasion test. The neat epoxy surface had a rougher surface with a significant proportion of micro-cleavage and fractures (FIG. 9(a)), indicating a plastic deformation with the low wear resistance of the neat epoxy coating. However, the nanofiller/epoxy groups had an improved surface (FIG. 9(b)), as the reduction was obtained in both amount and size of micro-grooves and fractures, indicating an enhancement of wear resistance when subjected to the abrasive forces.

In summary, the addition of GNP-C60 nanofillers resulted in a significant improvement in mechanical properties, as well as abrasion resistance. The GNP and C60 sample having a mix ratio of 25:75 had the maximum reinforcement, and Table 1 summarizes the increased properties.

TABLE 1
Improved mechanical properties of GNP-C60 nanocomposites

| | Improvement compared |
|---|---|
| | with neat epoxy |
| Mechanical properties | |
| Tensile strength | +129% |
| Failure strain | +53% |
| Young's modulus | +47% |
| Abrasion resistance | +110% |

1.4.3 Adhesion to the Substrate

The adhesion between a metallic coating to CFRP substrate was evaluated by following American Society for Testing and Materials (ASTM) D4541; to examine the effect of nanofiller reinforced coating, the adhesion was also measured for the example after applying GNP-C60 coating.

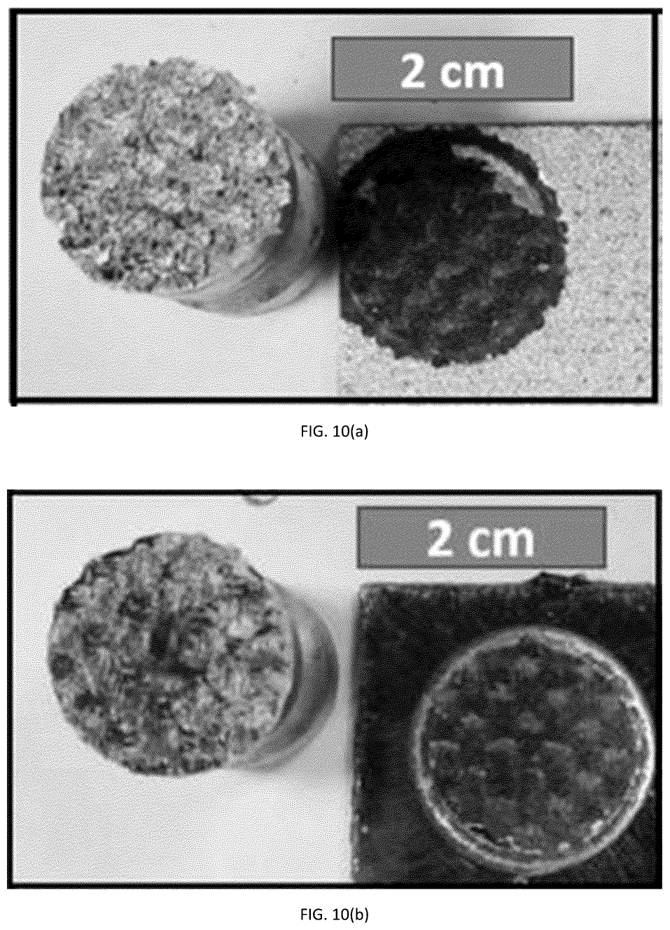

The pull-off strength between metallic coating on CFRP substrate was 46.4 kPa, with a failure mode of adhesive failure. As shown in FIG. 10(a), the metallic coating was completely detached from the substrates, indicating that the bonding between metallic coating and CFRP was low. This finding is reasonable as metallic coatings are difficult to adhere to the epoxy surface, which is consistent with observations by other researchers.

On the other hand, the presence of nanofiller reinforced coating significantly promoted the performance of the coating under the adhesion test. Table 2 summarizes the increased adhesion obtained from the nanofiller reinforced coating, and the bonding strength increased to from 320 psi to 650 psi after GNP-C60 nanocomposite coating was applied. As shown in FIG. 10(b), the example showed the coating had experienced cohesive failures, indicating that the coating system has satisfactory adhesion to the substrate. The nanocomposite improved adhesion to not only the surface of the substrate; in addition, it penetrated into the open pores and cracks of the metallic coating, which mitigated the defects in metallic coating and promoted the bonding to the CFRP substrate. Furthermore, no noticeable difference was observed for examples containing varied mixed ratios of nanofillers.

TABLE 2
Adhesion strength between different coatings and CFRP plates

| Sample | Adhesion (psi) |
|---|---|
| Metallic Coating to CFRP | 320 |
| GNP-C60 Nanocomposite Coated | 650 |
| Metallic Coating to CFRP | |

1.4.4 Water Repellency of the Coating Surface of the Invention

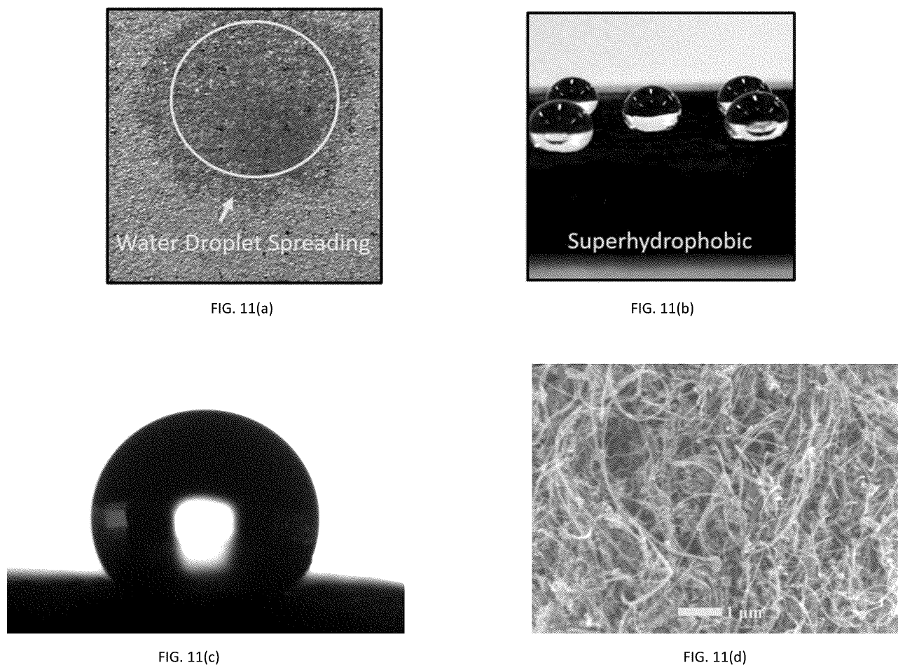

The water repellency of the coatings of the invention was characterized by a water contact angle test (FIG. 11(a)-11(d)). The metallic coating has extremely low water repellency as the water droplet spread out on the surface; thus, the example is considered hydrophilic. In addition, due to the open pores and cracks, the water was able to penetrate the metallic coating and reach the CFRP substrate, which significantly increased the potential of erosion damage.

On the other hand, the coating system of the invention showed dramatic improvement, as the water contact angle increased to 155 degrees, which is considered superhydrophobic. FIG. 11(b) shows a picture of water droplets on the coating surface, and uniformly distributed CNT nanoparticles on the top surface contributed to this phenomenon. The significantly increased water-repellency in the example was attributed to the uniformly distributed CNT on the surface, in which water droplets directly contact the hydrophobic surface of CNTs.

1.4.5 Anti-Icing Properties of the Coating Surface of the Invention (Ice Delay and Ice Formation)

To evaluate the coating systems of the invention for anti-icing application, two types of anti-icing properties of the coating system were determined, which includes icing delay and ice particle formation.

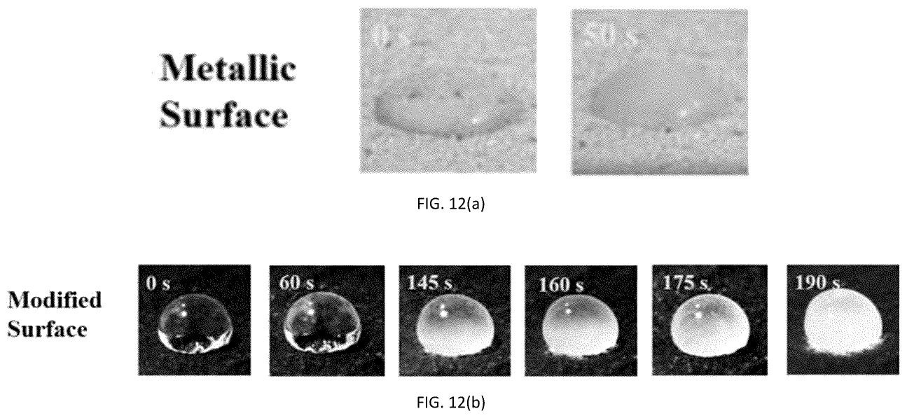

The icing delay test was performed in a chamber with a temperature controlled as −10° C., the sample was placed in the chamber for 20 mins before testing, so the surface temperature was the same as the environment. A water droplet (10 μL) was dropped from a height of 3 cm and impacted the sample surface; the water used in this test was mixed with ice to keep the temperature close to 0° C. During the test, the recording of freezing time was started when the water droplet contacted the sample surface. As shown in FIG. 12(a), for the metallic coating, a dome-shaped water droplet was formed on the surface instead of spreading out like during the water contact angle test (FIG. 11(a)). This result could be attributed to the low temperature on the example in FIG. 12(a), which freezed the water that contacted the interface. The total freezing duration for the water droplet on the metallic coating was 50 seconds.

In contrast, as shown in FIG. 12(b), the coating of the invention exhibited a significant delay on the freezing duration and the time of ice formation increased to 190 seconds. This occurred because the CNT modified surface has a much lower surface energy which substantially reduced the contact area between water droplet and coating surface. Additionally, the surface with high concentrated CNTs trapped a huge number of air pockets which reduced the thermal conductivity. In summary, the coating of the invention showed excellent icing delay properties, in which the freezing time of water is almost 3 times longer than the metallic coating.

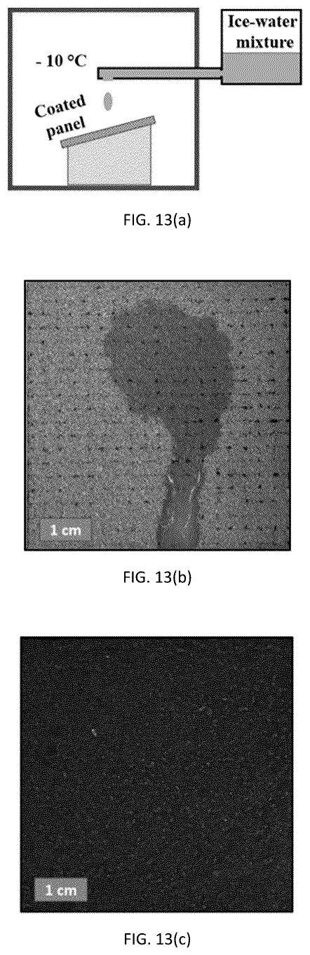

In addition, as shown in FIG. 13(a), a water-dripping test was utilized by a chamber; similar to the icing delay test, the temperature in the chamber was −10° C. and water was mixed with ice to simulate a freezing environment. During the test, the coated panels were kept in the chamber with a tilted angle of 15°, and water droplets were dripped to the sample surface from 10 cm above it. The dripping speed of water was controlled by a burette, and the flow speed was 2 mL/min with approximately 4 seconds per drop.

After 15 mins, no ice residues were found on the surface coated by the coating of the invention, as water droplets easily rolled off due to its excellent water repellency (FIG. 13(c)). In contrast, solid ice was formed on the surface coated with a metallic coating which contributed to its strong adhesion to water droplets (FIG. 13(b)). Furthermore, the water penetrated the GFRP substrate due to the open pores in the metallic coating, and the formation of ice in the interface could have resulted in severe damage to the coating.

1.4.6 Durability of the Coating of the Invention Under Abrasion Damages

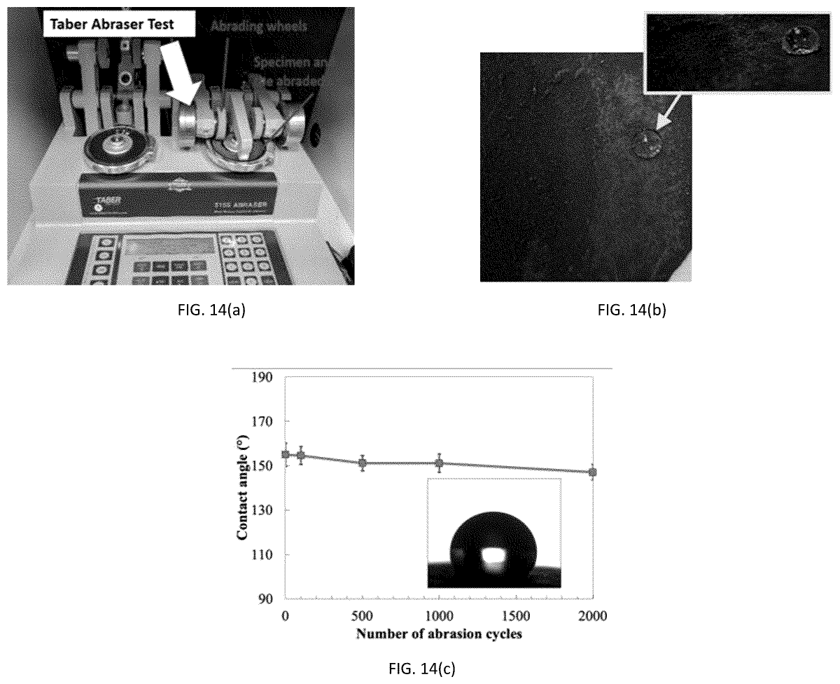

Instead of using light friction to evaluate the mechanical robustness of a superhydrophobic surface like in other studies, the Taber Abraser test was utilized, since it is a widely recognized method for testing a material's abrasion resistance. Two CS-10 abrading wheels were used, and a total of 2000 abrasion cycles was applied to each example, by following ASTM D4060 at a rotating speed of 72 rpm. As shown in FIG. 14(a) the abrading wheels created a circular abrasion mark area after the sample is tested.

A water contact angle test was performed on the coating surface of the invention after abrasion, and the results are shown in FIG. 14(c). The coating was durable enough to preserve hydrophobic characteristics after the abrasion test. No obvious change on water contact angle was found after 100 abrasion cycles; furthermore, the values remained above 150° after 1000 cycles and around 147° after 2000 cycles. FIG. 14(b) shows the interaction between a water droplet and coating surface after 2000 abrasion cycles, in which the water droplet remained spherical in shape even though the coating surface was covered by texture created by abrasion damages.

These results strongly suggested that the coating film was robust enough to maintain the superhydrophobic properties after exposure to the severe environment. Other hydrophobic coatings rarely have this great mechanical durability, which was attributed to the combination of strong abrasion resistance and well-dispersed CNTs on the surface of the coating system of the invention.

### Example 2: Graphene-Fullerene Binary Nanofiller Reinforced Polymer for Corrosion Protection Coating

2.1 Materials

The nanofillers include two types of carbon-based nanofillers, an epoxy resin, and a curing agent. The nanofillers are GNP and fullerene-C60 nanopowders, the average thickness of GNP is 8-12 nm (Cheap Tubes Inc., USA), whereas the fullerene-C60 particles have an average diameter of roughly 20 nm (Sigma-Aldrich Corp., USA). The epoxy coating consisted of a bisphenol A liquid epoxy resin and a polyamide curing agent, which is EPON™ resin 828 and EPIKURE™ Curing Agent 3175 (Hexion Inc., USA), correspondingly.

2.2 Fabrication

Fabrication of the nanocomposite coating consists of two steps, nanoparticles dispersion and mixing with the curing agent. First, both of the nanofillers were added into epoxy resin, followed by a high-shear disk mixing for 30 mins at 4000 rpm. The obtained slurry was then sonicated for 60 minutes on/off using a Misonix S1805 ultrasound device and a ¾″ probe at 100 percent amplitude. It is worth noting that throughout the dispersion process, an ice-water batch was administered to minimize overheating. Following the dispersion procedure, the curing agent was added to the mixture in a mole ratio of 1:1 between resin and curing agent, and a mechanical mixer was used at a speed of 600 revolutions per minute for ten minutes. The nanocomposites were applied to the steel substrate and set for at least three days before any characterization or performance evaluation was applied.

In this study, the total weight content of nanofiller was fixed at 1%, and the ratio between GNP and C60 was 25:75, 50:50, and 75:25 in order to examine the “hybrid effect” of the binary nanofiller reinforcements. For simplicity, the nanocomposites were labeled by the nanofiller's type and ratio; for example, the GF-epoxy (25:75) is the group that contains GNP and fullerene with a ratio of 25:75.

2.3 the Viscosity of the GNP-C60 Nanofiller-Epoxy Mixtures

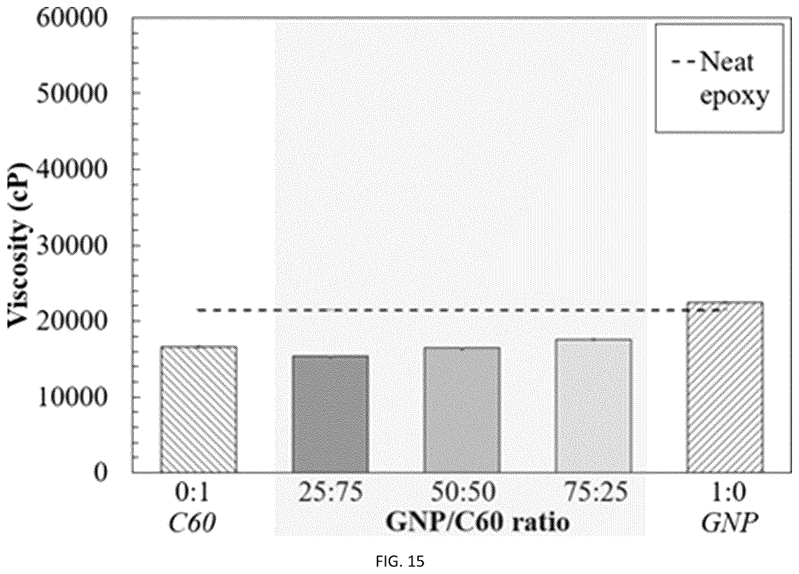

FIG. 15 summarizes the viscosity values for hybrid nanofiller reinforced mixtures; data for clean epoxy and single filler reinforced epoxy were utilized as references. When GNP-C60 with a ratio of 25:75 and 50:50 was used, the values dropped to 34400 cp and 27040 cp, respectively; ultimately, the combination reached a viscosity of 21600, which is comparable to that of pure epoxy. All the GNP-C60 hybrid filler groups exhibited a lower viscosity than plain epoxy or single filler groups. The hybrid impact of the two nanofillers increased dispersion and therefore decreased the viscosity of the mixtures, while the increased workability reduced flaws in the nanocomposite.

2.4 Particle Size Distribution of Nanofillers

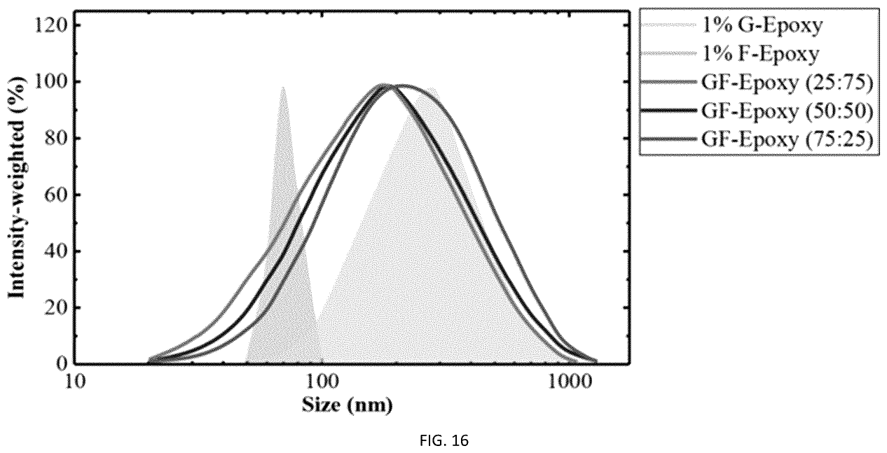

To characterize the synergistic effect of hybrid nanofillers, a particle size distribution test was performed for GNP-C60 hybrid nanofillers. FIG. 16 shows the particle size distributions of GNP, fullerene-C60, and the hybrid filler. Fullerene-C60 particles had narrow size distribution, and most of the particles ranged in 50-100 nm. The particle size of the GNPs was in the range of 100 to 1000 nm, as the GNP particles were stacked up sheets. The particle size distribution of the GNP-C60 hybrid fillers was narrower than that of GNP particles, and the average size of the GNP particles was much smaller. In addition, the minimum-sized particles in GNP-C60 were even smaller than the group with only fullerene-C60, indicating the interaction between these two nanofillers broke down the agglomeration of fullerene-C60 during the dispersion step. These findings demonstrated that the hybrid filler method substantially enhanced dispersion while exhibiting a decreased tendency for agglomeration.

2.5 Defect Analysis by Micro-CT Tomography Technique

2.5.1 Neat Epoxy

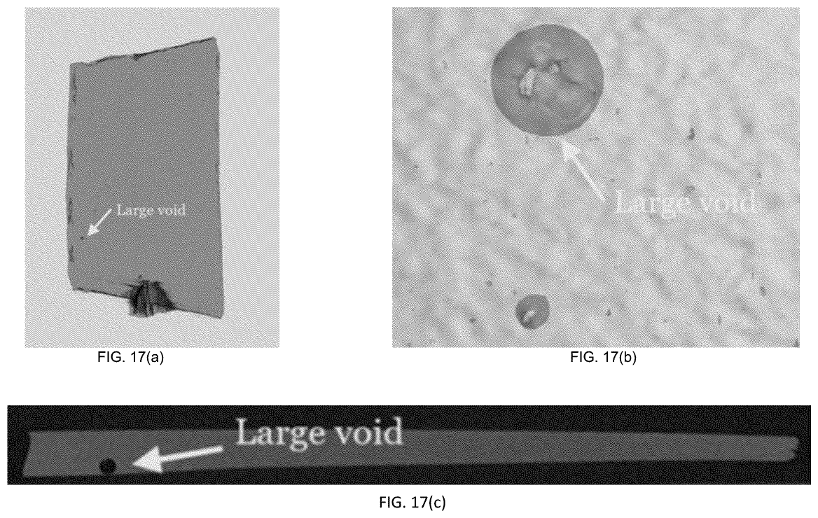

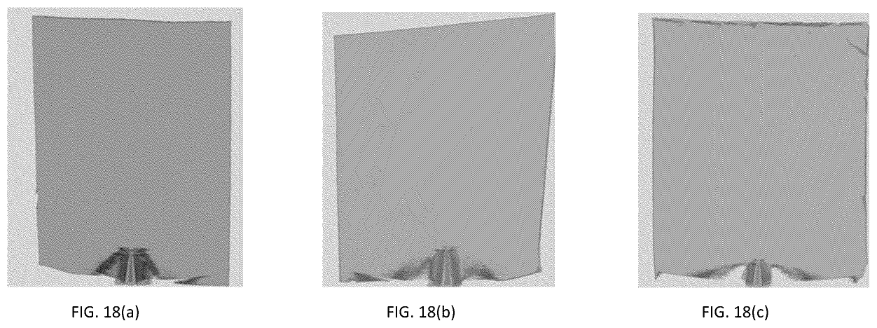

FIG. 17(a)-17(c) show the 3-dimensional (3D) images obtained from the Micro-CT scan for the neat epoxy sample. The neat epoxy had a low volume of voids, as most of the scanned areas are perfect layers like FIG. 17(b). The low volume of voids in the coating film leads to a high barrier performance and good mechanical properties, and that is why epoxy is one of the most commonly used protective coatings in the industry. However, as shown in FIG. 17(b), a large void could be found in the coating layer, which was possibly created during the application process, as the epoxy resin has relatively high viscosity. The 3D image of the large void is shown in FIG. 17(c), which confirmed that the observed defect of the epoxy coating was the void caused by entrapped air.

2.5.2 GNP-C60 Epoxy Nanocomposite Coatings

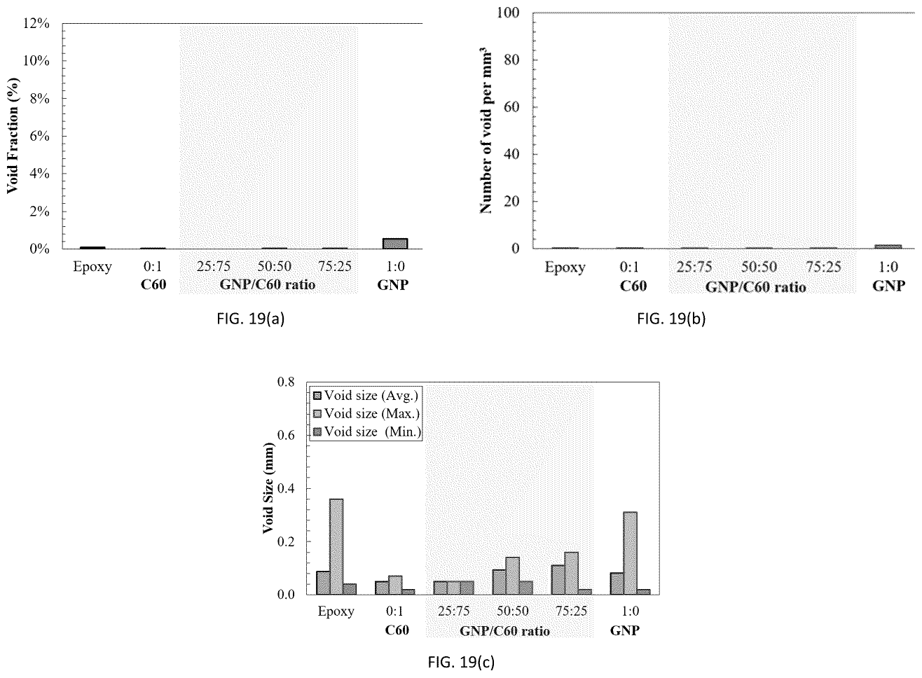

The defect analysis was utilized to explain why the GNP-C60 hybrid nanofiller can provide good reinforcements in nanocomposites while the GNP-CNT nanofiller cannot. As shown in FIGS. 18(a)-18(c), the inclusion of fullerene-C60 substantially decreased the defects in the nanocomposite, a result that was also found with the GNP/NS hybrid nanofillers. As shown in FIG. 19(a) and FIG. 19(b), regardless of the ratio of GNP to fullerene nanofillers, the GNP-C60 groups have a low void percentage and a small number of voids. The void size was substantially decreased when the groups with a ratio of 25:75 were compared to the plain epoxy and GNP-epoxy groups (FIG. 19(c)).

As show in FIG. 19(a) and FIG. 19(b), the disadvantage of GNP-epoxy nanocomposite is that the presence of GNPs has no discernible effect on the reduction of matrix defects. Additionally, increasing GNP content exacerbated flaws, ultimately resulting in material deterioration. However, the presence of Fullerene mitigated the flaws introduced by the GNPs, resulting in a more robust nanocomposite matrix. On the other hand, the impermeability of GNPs enhanced the nanocomposite's barrier performance, which was not possible with silica nanopowders. In summary, the hybrid GNP-C60 nanofillers enhanced nanofiller reinforcement by providing both better characteristics and decreased flaws.

On the other hand, the GNP-C60 binary nanofiller had a positive influence on minimizing the coating defect. In particular, the size of the voids in the GF-epoxy (25:75) group was even lower than the C60-epoxy group, indicating that the interaction between GNP and C60 particles resulted in a better dispersion state for both nanoparticles.

2.6 Corrosion Barrier Performance of the GNP-C60 Reinforced Epoxy

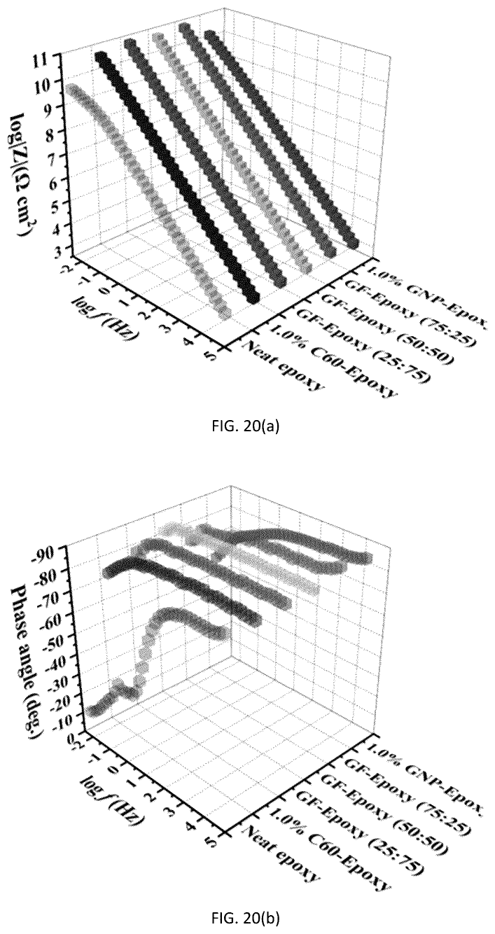

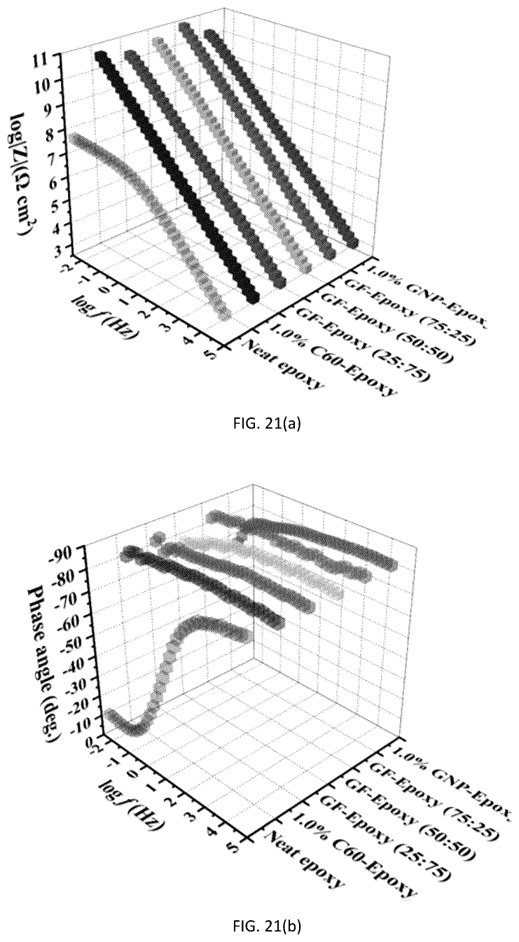

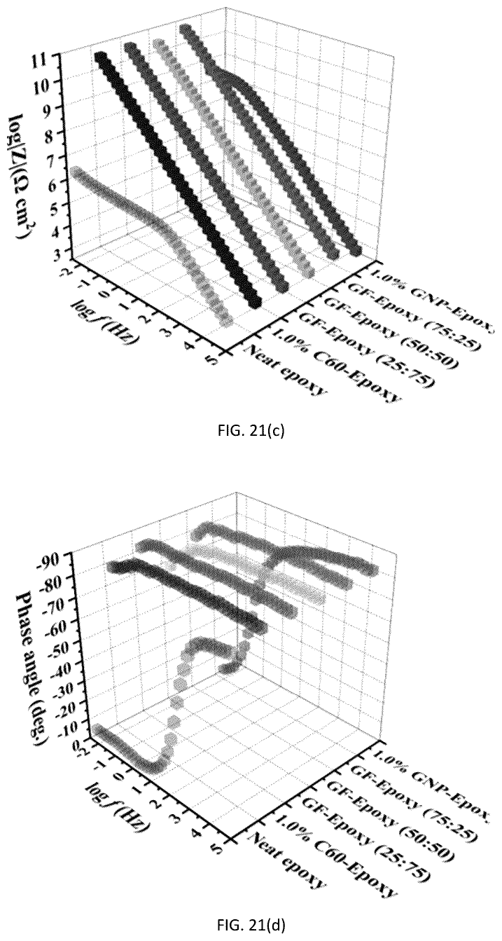

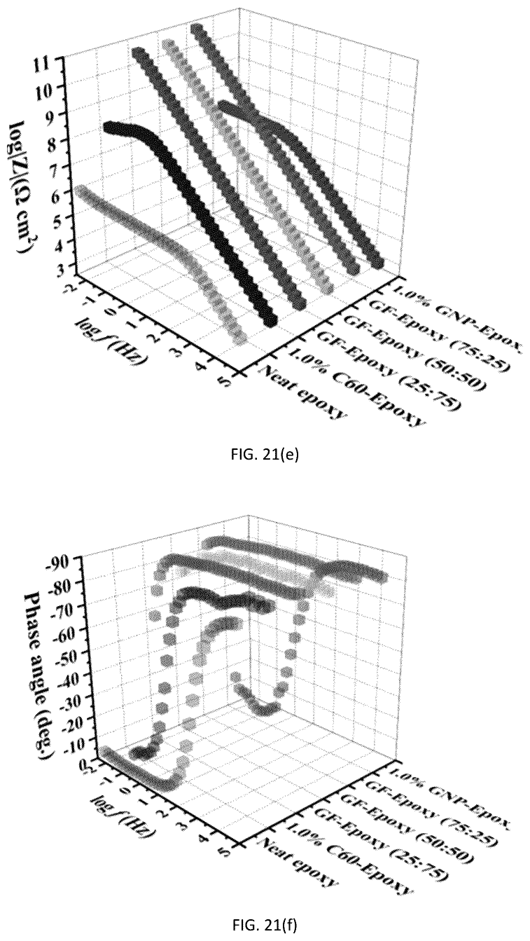

The corrosion resistance of the GNP/fullerene-C60 hybrid nanofiller reinforced epoxy coating was obtained by electrochemical impedance spectroscopy (EIS) measurement, which includes Bode plots before and after salt fog spray exposure, as shown in FIG. 20(a)-20(b) and FIGS. 21(a)-21(f). To evaluate the performance of GNP-C60 hybrid nanofillers, the results of the neat epoxy and single nanofiller (1% fullerene-C60 and GNP) groups were used to compare with the coatings with GNP-C60 hybrid nanofillers.

2.6.1 Corrosion Barrier Performance at Fresh Stage

The graphene/fullerene-C60 groups had excellent corrosion resistance reinforcement. Compared with the neat epoxy, all the GF-epoxy groups had phase angle values that remained close to 90 degrees in all the tested frequencies (FIG. 20(b)), reflecting that the coating films behaved as an intact layer to protect the substrates. Moreover, all the GF-epoxy groups exhibited higher impedance (FIG. 20(a)), suggesting that the protective coatings have excellent corrosion barrier performance. The hybrid filler groups displayed stronger corrosion resistance reinforcement than the single filler groups, as the increase in |Z|0.01 Hz values and phase angle.

The values of |Z|0.01 Hz for the GF-epoxy coatings were around 6¹⁰, higher than the neat epoxy coating by 1 order. At this stage, even the |Z|0.01 Hz values of GF-epoxy groups are slightly higher than the GNP-epoxy group, the single filler and hybrid filler reinforcement showed no significant difference in the corrosion resistance performance.

2.6.2 Long-Term Corrosion Barrier Performance

The EIS data were collected after 100 (FIG. 21(a)-21(b)), 200 (FIG. 21(c)-21(d)), and 500 (FIG. 21(e)-21(f)) hours of salt spray exposure. Similar to the fresh stage, all the nanocomposites exhibit excellent anti-corrosion performance, as the coatings containing either single or hybrid nanofillers showed no degradation. However, the GF-epoxy groups had a slight difference in corrosion resistance after exposure. Surprisingly, all the GF-epoxy groups had excellent anti-corrosion performance after 200 hours of exposure, as neither impedance nor phase angle plots showed degradation. On the other hand, for the single filler reinforced coatings, the GNP reinforced epoxy had a remarkable drop of impedance value, but the epoxy reinforced with fullerene-C60 nanofillers remained undamaged; hence, neither the single filler nor the hybrid filler reinforcement had any significant advantages in their corrosion resistance performance after 200 hours exposure (FIG. 21(c)-21(d)). Overall, all the GF-epoxy samples had similar profiles; this behavior revealed that excellent corrosion protection properties were maintained at 200 hours, which conclusion from EIS results indicated that the coating remain intact with excellent corrosion resistance.

After 500 hours of exposure, the GF-epoxy groups have shown much stronger enhancement compared with single filler groups, regardless of exposure time, as shown in FIGS. 21(e)-21(f). All the coatings with GNP-C60 hybrid nanofillers had extraordinary anti-corrosion performance, as impedance value was maintained during exposure, which was over 10¹⁰ 1 cm² after 500 hours exposure. In addition, the phase angle values remained close to 90 degrees in most of the tested frequency regions. For the single filler reinforced coatings, the 1% F-epoxy has weaker corrosion resistance as the log |Z|_{0.01Hz} value dropped to 108, and the lowest impedance values were obtained in the 1% GNP-epoxy, which was around 10⁷ Ωcm².

The results indicated that the presence of C60 particles significantly reinforced GNP's performance in the coating matrix, which showed a good agreement with the EIS measurement at the fresh stage.

2.7 Tensile Properties of the GNP-C60 Reinforced Epoxy

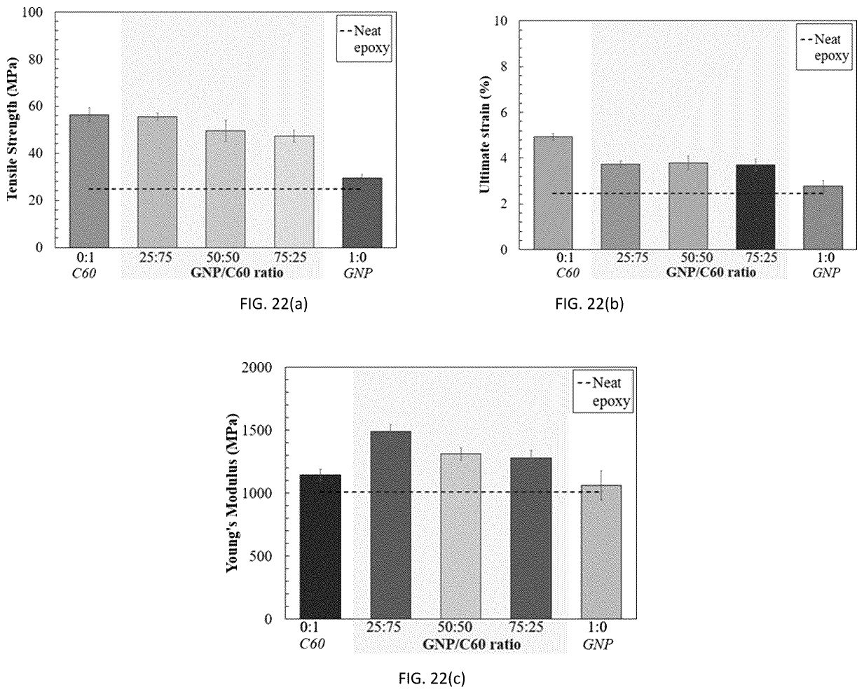

The tensile properties of hybrid nanofiller reinforced epoxy was characterized by the coupon tensile test (ASTM D638). To evaluate the influence of varied mix ratios in the hybrid nanofillers, the relationship between mix ratio vs. tensile strength (FIG. 22(a)), ultimate strain (FIG. 22(b)), and Young's modulus (FIG. 22(c)) were determined.

FIG. 22(a) revealed that all tested nanofiller reinforced composites improved tensile strength compared to the neat epoxy. In the hybrid filler reinforced composites, the GF-epoxy (25:75) group (56 MPa) had the highest reinforcement of tensile strength, with an improvement of 124% compared with neat epoxy identical to the group with only fullerene-C60 reinforcement. The other two hybrid filler reinforced composites, the GF-epoxy (50:50) and (75:25) groups possessed tensile strength values of 50 MPa and 47 MPa, respectively. This observation indicated that, with less amount of C60 particles, the GNP-C60 hybrid fillers achieved similar improvement in tensile strength compared with C60 particles. The results revealed that the tensile strength was reduced with a higher amount of GNP nanoparticles, which was not surprising as the addition of GNP did not show significant reinforcement on mechanical strength. This strong evidence indicated that the combination of GNP and C60 in a ratio of 25:75 formed the most robust nanoparticles network. However, even though the GF-epoxy (75:25) group had the lowest tensile strength in the GF-epoxy groups (47 MPa), it still outperformed all the CNT and GNP single filler reinforced composites.

Unlike the tensile strength, the hybrid nanofiller composites showed a lower ultimate strain than the group with only C60 particles. As shown in FIG. 22(b), all the GF-epoxy groups had similar values of ultimate strain, which were around 3.7%, indicating that the presence of GNP led to a decrease in the flexibility of the composites. Like tensile strength, the GF-epoxy groups outperformed all the CNT and GNP groups on the elasticity of the composites.

As shown in FIG. 22(c), the GF-epoxy (25:75) group had the most significant increase in Young's modulus value at 47%, while the other hybrid filler systems also exhibited significant enhancement on Young's modulus. Similar to the tensile strength, the Young's modulus value decreased slightly when more GNP was added. This observation is reasonable as the GNP has less reinforcement on materials stiffness compared with C60 particles. In addition, all the GF-epoxy groups have higher Young's modulus values than all the single filler composites.

The overall results suggested that the addition of C60 increased the overall tensile properties of the GNP-epoxy composite. Thus, a preferred ratio between GNP and C60, in which the strength, strain, and stiffness of the composites could be improved, was 25:75.

2.8 Abrasion Resistance of the GNP-C60 Reinforced Epoxy

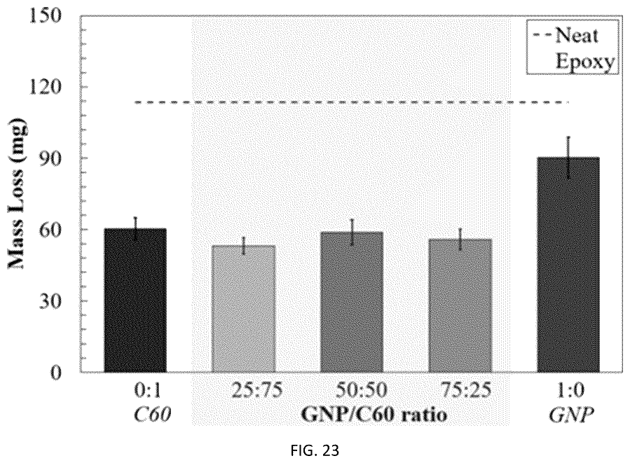

FIG. 23 shows the mass loss value from the abrasion test; thus, the neat epoxy was used as a reference to compare with all the nanofiller reinforced coatings. As shown in FIG. 23, the mass loss of the neat epoxy film was 114 mg after 1000 abrasion cycles. C60 and GNP reinforced epoxy had improved abrasion resistance, in which the mass loss was around 60 mg and 90 mg, respectively. The addition of both GNP and fullerene-C60 improved the abrasion resistance of the epoxy resin, but the improvement of fullerene-C60 was significantly stronger than graphene nanoplatelets.

For the composites containing hybrid nanofiller, the presence of fullerene-C60 dramatically increased the abrasion resistance, as the mass loss values of all the GF-epoxy groups were lower than the epoxy that contained only GNP nanofillers. In particular, the mass loss of GF-epoxy groups was slightly lower than the C60/epoxy group, indicating the hybrid nanofiller systems have a more robust nanoparticles network against the abrasive force. 1% GF-epoxy (25:75) and 1% GF-epoxy (75:25) groups had the highest reinforcement on abrasion resistance, in which the mass loss was around 54 mg after 1000 abrasion cycles.

The claimed invention is:

1. A curable coating composition comprising:
a) a first layer comprising at least one epoxy resin and at least one hybrid nanofiller; and
b) a second layer comprising carbon nanotubes (CNTs).

2. The curable coating composition of claim 1, wherein the coating is superhydrophobic.

3. The curable coating composition of claim 1, wherein the epoxy resin is selected from the group consisting of bisphenol-based resin, novolac resin, aliphatic resin, halogenated resin, diluent resin, glycidol amine resin, and mixtures thereof.

4. The curable coating composition of claim 1, wherein the epoxy resin is selected from a bisphenol A/epichlorohydrin epoxy resin.

5. The curable coating composition of claim 1, wherein the epoxy resin is present in the first layer in an amount ranging from about 35-65 wt. %, based on the total solid content of the first layer.

6. The curable coating composition of claim 1, wherein the hybrid nanofiller is present in the first layer in an amount ranging from about 0.1-10 wt. %, based on the total solid content of the first layer.

7. The curable coating composition of claim 1, wherein the hybrid nanofiller comprises graphene nanoplatelets (GNP) and fullerene-C60 nanopowder.

8. The curable coating composition of claim 1, wherein the ratio of GNP:fullerene-C60 nanopowder in the first layer ranges from about 25:75 to 75:25.

9. The curable coating composition of claim 7, wherein the GNP has an average thickness of about 8-12 nm and an average specific surface area of about 500-700 m²/g.

10. The curable coating composition of claim 7, wherein the fullerene-C60 nanopowder has an average particle size of about 20 nm.

11. The curable coating composition of claim 1, wherein the first layer further comprises at least one curing agent.

12. The curable coating composition of claim 11, wherein the curing agent is selected from the group consisting of at least one polyamine, at least one polyamide, and mixtures thereof.

13. The curable coating composition of claim 11, wherein the curing agent is a polyamide curing agent.

14. The curable coating composition of claim 11, wherein the mol ratio of the epoxy resin to the at least one curing agent ranges between 1:0.08 and 1:1.25.

15. The curable coating composition of claim 1, wherein the CNTs are uniformly distributed in the second layer.

16. The curable coating composition of claim 1, wherein the CNTs have an average outside diameter of about 8-15 nm and an average length of about 10-50 um.

17. A metallic coated substrate composite comprising:
a) a substrate;
b) a metallic layer deposited on at least a part of at least one surface of the substrate; and
c) the curable coating composition of claim 1 deposited on at least a part of the surface of the metallic layer.

18. The metallic coated substrate of claim 17, wherein the substrate is a carbon fiber reinforced polymer (CFRP).

19. The metallic coated substrate of claim 17, wherein the metallic layer comprises an aluminum alloy.

20. The metallic coated substrate of claim 17, wherein the curable coating composition is cured to form a cured coating composition.

21. A method for coating the surface of a metallic coated substrate comprising the steps of:
providing a substrate, wherein at least a part of at least one surface of the substrate is coated with a metallic layer;
applying the first layer of the curable coating composition of claim 1 to at least a part of the surface of the metallic layer to form a first coated surface;
applying the second layer of the curable coating composition of claim 1 to at least a part of the surface of the first coated surface to form a second coated surface; and
curing the first coated surface.

22. The method of claim 21, wherein the substrate is a carbon fiber reinforced polymer (CFRP).

23. A curable coating composition comprising:
a) at least one hybrid nanofiller;
b) at least one epoxy resin; and
c) at least one curing agent.

24. The curable coating composition of claim 23, wherein the hybrid nanofiller is present in an amount ranging from about 0.1-10 wt. %, based on the total solid content of the curable coating composition.

25. The curable coating composition of claim 23, wherein the hybrid nanofiller comprises graphene nanoplatelets (GNP) and fullerene-C60 nanopowder.

26. The curable coating composition of claim 25, wherein the ratio GNP:fullerene-C60 nanopowder ranges from about 25:75 to 75:25.

27. The curable coating composition of claim 25, wherein the GNP has an average thickness of about 8-12 nm.

28. The curable coating composition of claim 25, wherein the fullerene-C60 nanopowder has an average particle size of about 20 nm.

29. The curable coating composition of claim 23, wherein the epoxy resin is selected from the group consisting of bisphenol-based resin, novolac resin, aliphatic resin, halogenated resin, diluent resin, glycidol amine resin, and mixtures thereof.

30. The curable coating composition of claim 23, wherein the epoxy resin is selected from bisphenol A/epichlorohydrin epoxy resin.

31. The curable coating composition of claim 23, wherein the curing agent is selected from the group consisting of at least one polyamine, at least one polyamide, and mixtures thereof.

32. The curable coating composition of claim 23, wherein the curing agent is a polyamide curing agent.

33. The curable coating composition of claim 23, wherein the mol ratio of the epoxy resin to the at least one curing agent ranges between 1:0.08 and 1:1.25.

34. A method of making the curable coating composition of claim 23, comprising the steps of:
dispersing the hybrid nanofiller in the epoxy resin to form a slurry; and
adding the curing agent to the slurry.

35. A cured coating composition, comprising the curable coating composition of claim 23.

36. The cured coating composition of claim 35, wherein the cured coating composition is corrosion resistant.

37. The cured coating composition of claim 35, wherein the cured coating composition is abrasion resistant.

38. A metallic coated substrate composite comprising:
a) a substrate; and
b) the curable coating composition of claim 23 deposited on at least a part of the surface of the substrate.

39. The metallic coated substrate of claim 38, wherein the substrate is steel.

40. The metallic coated substrate of claim 38, wherein the curable coating composition is cured to form a cured coating composition.

41. A method for coating the surface of a metallic coated substrate comprising the steps of:
providing a substrate;
applying the curable coating composition of claim 23 to at least a part of the surface of the substrate to form a first coated surface; and
curing the first coated surface.

42. The method of claim 41, wherein the substrate is steel.
